(19) United States
(12) Patent Application Publication
(10) Pub. No.: US 2022/0322827 A1
(43) Pub. Date: Oct. 13, 2022

(54) SLIP-RESISTANT SEAT

(71) Applicants: LI-SHENG CHIEN, Taipei City (TW); CHIEN-CHANG HO, Taipei City (TW)

(72) Inventors: LI-SHENG CHIEN, Taipei City (TW); CHIEN-CHANG HO, Taipei City (TW)

(21) Appl. No.: 17/227,396

(22) Filed: Apr. 12, 2021

(51) Int. Cl. A47B 91/08; A47C 7/00; F16B 47/00

(52) U.S. Cl. CPC A47B 91/08; A47C 7/002; F16B 47/00; A47K 3/122

(57) ABSTRACT

A slip-resistant seat includes a seat and anti-slip units. The seat includes a rest portion, legs and butting portions. The legs are disposed below the rest portion. The butting portions are disposed beside the legs, respectively. The anti-slip units are disposed at the legs, respectively. The anti-slip units each include a fitting element, anti-slip portion, adsorption element and force-bearing portion. The adsorption elements are disposed beside the fitting elements, respectively. The fitting elements are higher than the adsorption elements. The anti-slip portions are disposed at the bottoms of the fitting elements. The force-bearing portions are disposed on the top surfaces of the adsorption elements. The fitting elements are fitted to the bottoms of the legs. The butting portions are separated from the force-bearing portions, respectively, by a prepressing distance. When the seat carries a load, the fitting elements are pressed downward, and the prepressing distance shortens.

### BACKGROUND OF THE INVENTION

### 1. Field of the Invention

The present disclosure relates to slip-resistant seats, and in particular to a slip-resistant seat which is unlikely to slip but is easy to fix in place.

### 2. Description of the Related Art

A conventional seat typically has its legs equipped with non-slip pads.

However, in practice, the leg pads might fail to bring an anti-slip effect, especially on smooth or wet surfaces, thereby posing a threat to user safety.

Therefore, it is important to provide a slip-resistant seat which is unlikely to slip but is easy to fix in place.

### BRIEF SUMMARY OF THE INVENTION

An objective of the present disclosure is to provide a slip-resistant seat which is unlikely to slip but is easy to fix in place.

To achieve at least the above objective, the present disclosure provides a slip-resistant seat which comprises a seat and a plurality of anti-slip units. The seat comprises a rest portion, a plurality of legs and a plurality of butting portions. The legs are disposed below the rest portion. The butting portions are disposed beside the legs, respectively. The anti-slip units are disposed at the legs, respectively. The anti-slip units each comprise a fitting element, an anti-slip portion, an adsorption element and a force-bearing portion. The adsorption elements are disposed beside the fitting elements, respectively. The fitting elements are higher than the adsorption elements, respectively. The anti-slip portions are disposed at the bottoms of the fitting elements, respectively. The force-bearing portions are disposed on the top surfaces of the adsorption elements, respectively. The fitting elements are fitted to the bottoms of the legs, respectively. The butting portions are separated from the force-bearing portions, respectively, by a prepressing distance.

Regarding the slip-resistant seat, the legs each further comprise an extension portion, and the butting portions are disposed at the extension portions, respectively.

Regarding the slip-resistant seat, a plurality of engaging grooves are disposed at the end of the bottom of each said leg, and a plurality of limiting portions are inwardly disposed at the bottom of each said fitting element, allowing the limiting portions to be fitted to the engaging grooves, respectively.

Regarding the slip-resistant seat, the adsorption elements are suction cups, and a force-applying portion is disposed at the rim of each said adsorption element.

Regarding the slip-resistant seat, the fitting elements each further comprise a connection portion, and the connection portions connect to the force-bearing portions, respectively.

The slip-resistant seat of the present disclosure has some advantages. When a person sits or stands on the seat placed on a flat surface, with the adsorption elements in contact with the flat surface, not only are the fitting elements pressed downward to enable the anti-slip portions to bring an anti-slip effect, but the prepressing distance also shortens to enable the butting portions to abut against the force-bearing portions, respectively, thereby allowing the adsorption elements to be firmly attached to the flat surface. Therefore, the slip-resistant seat is unlikely to slip but is easy to fix in place.

### BRIEF DESCRIPTION OF THE DRAWINGS

FIG. 1 is a perspective view of a slip-resistant seat of the present disclosure.

FIG. 2 is an exploded view of the slip-resistant seat of the present disclosure.

FIG. 3 is a lateral view of an anti-slip unit of the present disclosure.

FIG. 4 is a top view of the anti-slip unit of the present disclosure.

FIG. 5 is a bottom view of the anti-slip unit of the present disclosure.

FIG. 6 is a schematic view of how the anti-slip unit of the present disclosure functions.

FIG. 7 is another schematic view of how the anti-slip unit of the present disclosure functions.

### DETAILED DESCRIPTION OF THE INVENTION

To facilitate understanding of the object, characteristics and effects of this present disclosure, embodiments together with the attached drawings for the detailed description of the present disclosure are provided.

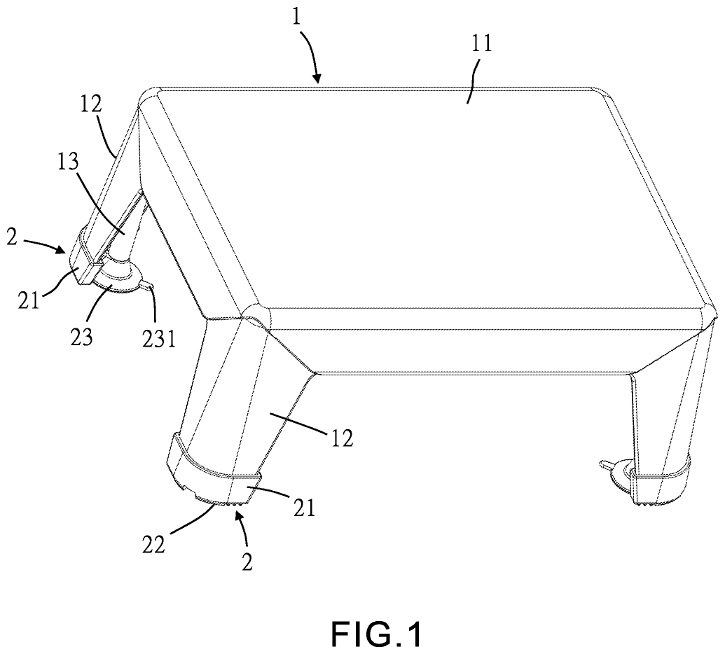

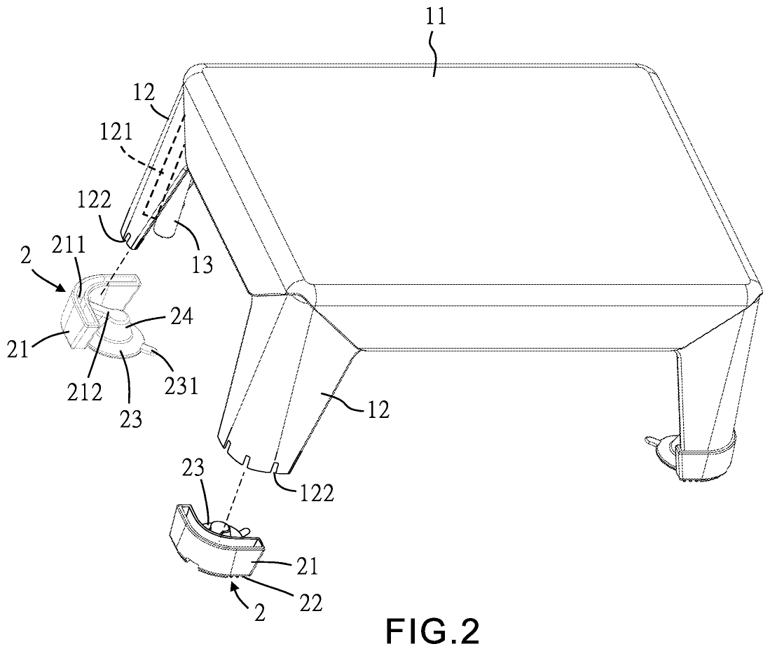

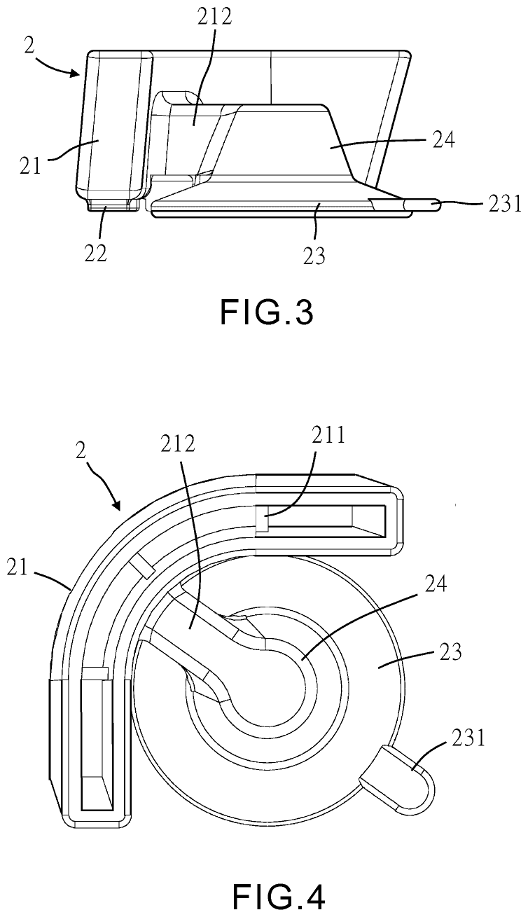

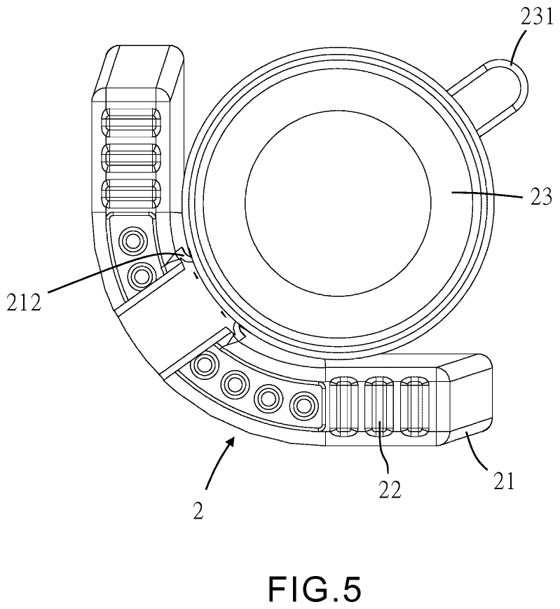

Referring to FIG. 1 through FIG. 7, the present disclosure provides a slip-resistant seat which comprises a seat 1 and a plurality of anti-slip units 2.

The seat 1 comprises a rest portion 11, a plurality of legs 12 and a plurality of butting portions 13. The legs 12 are disposed below the rest portion 11. The butting portions 13 are disposed beside the legs 12, respectively.

The anti-slip units 2 are disposed at the legs 12, respectively. The anti-slip units 2 each comprise a fitting element 21, an anti-slip portion 22, an adsorption element 23 and a force-bearing portion 24. The adsorption elements 23 are disposed beside the fitting elements 21, respectively. The fitting elements 21 are higher than the adsorption elements 23, respectively. The anti-slip portions 22 are disposed at the bottoms of the fitting elements 21, respectively. The force-bearing portions 24 are disposed on the top surfaces of the adsorption elements 23, respectively. The fitting elements 21 are fitted to the bottoms of the legs 12, respectively. The butting portions 13 are separated from the force-bearing portions 24, respectively, by a prepressing distance a.

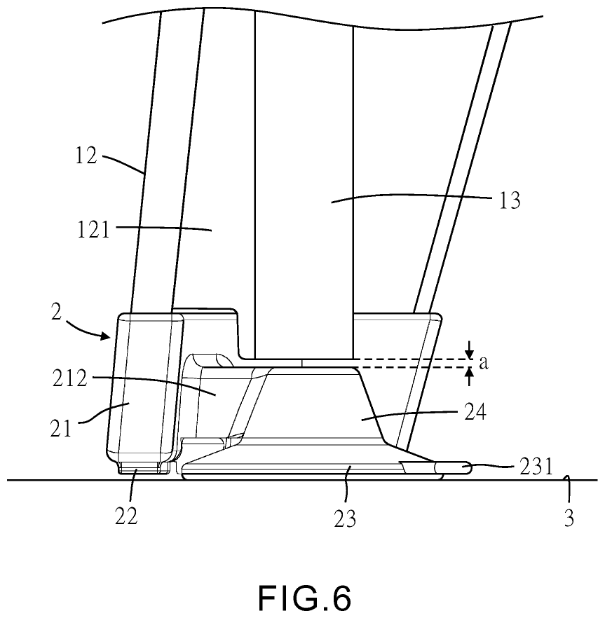

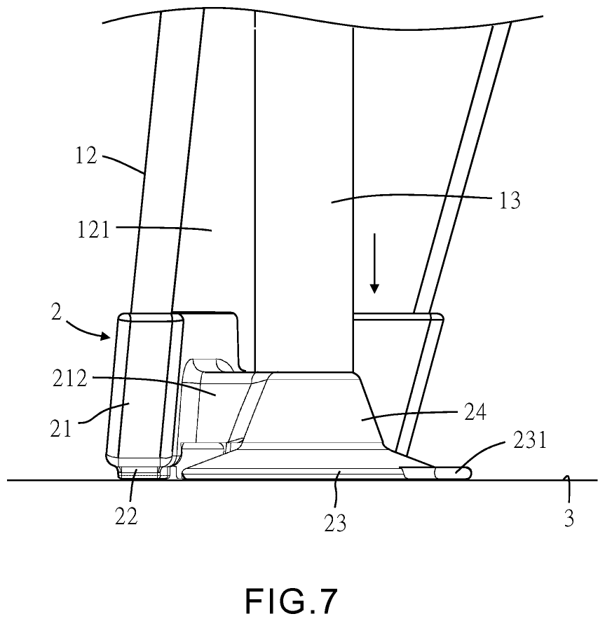

To use the slip-resistant seat of the present disclosure, a user places the legs 12 of the seat 1 on a flat surface 3 (such as a floor, a tile surface or the bottom surface of a bathtub) in such a manner that the adsorption elements 23 of the anti-slip units 2 are in contact with the flat surface 3, as shown in FIG. 6. When the user sits or stands on the rest portion 11, the fitting elements 21 are pressed downward to enable the anti-slip portions 22 of the anti-slip units 2 to come into contact with the flat surface 3. Thus, not only do the anti-slip portions 22 of the anti-slip units 2 bring an anti-slip effect, but the prepressing distance a also shortens as a result of the user's sitting or standing on the rest portion 11, thereby allowing the butting portions 13 to abut against the force-bearing portions 24, respectively. Consequently, the butting portions 13 operate in conjunction with the force-bearing portions 24, respectively, thereby allowing the adsorption elements 23 to be firmly attached to the flat surface 3, as shown in FIG. 7. Therefore, the seat 1 is unlikely to slip but is easy to fix in place.

In an embodiment of the present disclosure, the legs 12 each further comprise an extension portion 121, and the butting portions 13 are disposed at the extension portions 121, respectively. The extension portions 121 provide structural support to the butting portions 13, respectively, such that the butting portions 13 abut against the force-bearing portions 24, respectively. Thus, the butting portions 13 operate in conjunction with the force-bearing portions 24, respectively, thereby allowing the adsorption elements 23 to be firmly attached to the flat surface 3. Therefore, the seat 1 is unlikely to slip but is easy to fix in place.

According to the present disclosure, the extension portions 121 and the butting portions 13 extend from the bottom surface of the rest portion 11 to the bottoms of the legs 12, respectively. Alternatively, the extension portions 121 and the butting portions 13 may be disposed at the legs 12, respectively, in such a manner (not shown) to optimize cost control.

In an embodiment of the present disclosure, a plurality of engaging grooves 122 are disposed at the end of the bottom of each said leg 12, and a plurality of limiting portions 211 are inwardly disposed at the bottom of each said fitting element 21, allowing the limiting portions 211 to be fitted to the engaging grooves 122, respectively. Thus, the engaging grooves 122 and the limiting portions 211 operate in conjunction with each other to enable the anti-slip units 2 to be firmly fitted to the bottoms of the legs 12 through the fitting elements 21, respectively, to preclude detachment which might otherwise happen during transportation.

As shown in the accompanying diagram of the present disclosure, the legs 12 are L-shaped, so are the fitting elements 21. However, the present disclosure is not limited thereto.

In an embodiment of the present disclosure, the adsorption elements 23 are suction cups, and a force-applying portion 231 is disposed at the rim of each said adsorption element 23. When the user sits or stands on the rest portion 11, the prepressing distance a shortens; thus, the butting portions 13 abut against the force-bearing portions 24, respectively, to discharge gas otherwise trapped between each adsorption element 23 and the flat surface 3, allowing a vacuum to be created between each adsorption element 23 and the flat surface 3. In the presence of the vacuum, the adsorption elements 23 are firmly attached to the flat surface 3 because of the coordination of the butting portions 13 and the force-bearing portions 24. Therefore, the seat 1 is unlikely to slip but is easy to fix in place, because of the anti-slip portions 22 and the adsorption elements 23 of the anti-slip units 2.

To move the seat 1, the user exerts a force on the force-applying portion 231 of the adsorption elements 23, such that a gap is formed between each adsorption element 23 and the flat surface 3 to admit gas and thereby abolish the vacuum.

In an embodiment of the present disclosure, the fitting elements 21 each further comprise a connection portions 212, and the connection portions 212 connect to the force-bearing portions 24, respectively. The connection portions 212 enable the adsorption elements 23 and the force-bearing portions 24 to be integrally disposed beside the fitting elements 21, respectively; thus, not only are the anti-slip units 2 structurally stable, but the connection portions 212 also provide support to the force-bearing portions 24 and the adsorption elements 23 and keep the prepressing distance a within a predetermined range. Consequently, the butting portions 13 abut against the force-bearing portions 24, respectively, thereby allowing the adsorption elements 23 to be firmly attached to the flat surface 3. Therefore, the seat 1 is unlikely to slip but is easy to fix in place.

While the present disclosure has been described by means of specific embodiments, numerous modifications and variations could be made thereto by those skilled in the art without departing from the scope and spirit of the present disclosure set forth in the claims.

1. A slip-resistant seat, comprising:
a seat comprising a rest portion, a plurality of legs and a plurality of butting portions, the legs being disposed below the rest portion, the butting portions being disposed beside the legs, respectively; and
a plurality of anti-slip units disposed at the legs, respectively, and each comprising a fitting element, an anti-slip portion, an adsorption element and a force-bearing portion, the adsorption elements being disposed beside the fitting elements, respectively, the fitting elements being higher than the adsorption elements, respectively, the anti-slip portions being disposed at bottoms of the fitting elements, respectively, the force-bearing portions being disposed on top surfaces of the adsorption elements, respectively, the fitting elements being fitted to bottoms of the legs, respectively, and the butting portions being separated from the force-bearing portions, respectively, by a prepressing distance,
wherein the fitting element is deformably connected to the force-bearing portion, and when the rest portion is loaded along the direction of gravity, the fitting element deforms along the direction of gravity and makes the butting portion compress the force-bearing portion.

2. The slip-resistant seat of claim 1, wherein the legs each further comprise an extension portion, and the butting portions are disposed at the extension portions, respectively.

3. The slip-resistant seat of claim 1, wherein a plurality of engaging grooves are disposed at the end of the bottom of each said leg, and a plurality of limiting portions are inwardly disposed at the bottom of each said fitting element, allowing the limiting portions to be fitted to the engaging grooves, respectively.

4. The slip-resistant seat of claim 1, wherein the adsorption elements are suction cups, and a force-applying portion is disposed at a rim of each said adsorption element.

5. The slip-resistant seat of claim 1, wherein the fitting elements each further comprise a connection portion, and the connection portions connect to the force-bearing portions, respectively.
